(19) United States
(12) Patent Application Publication
(10) Pub. No.: US 2014/0253286 A1
(43) Pub. Date: Sep. 11, 2014

(54) Wireless Tracking and Security System

(71) Applicants: James S. Bianco, Suffield, CT (US); William G. Lucas, JR., Suffield, CT (US)

(72) Inventors: James S. Bianco, Suffield, CT (US); William G. Lucas, JR., Suffield, CT (US)

(21) Appl. No.: 14/198,929

(22) Filed: Mar. 6, 2014

Related U.S. Application Data
(60) Provisional application No. 61/781,113, filed on Mar. 14, 2013.
(60) Provisional application No. 61/773,400, filed on Mar. 6, 2013.

(51) Int. Cl. G07C 1/02; G07C 9/00

(52) U.S. Cl. CPC G07C 1/02; G07C 9/00158; G07C 9/00031; G07C 9/00563
USPC 340/5.31; 340/5.2; 340/5.64; 340/5.52

(57) ABSTRACT

A wireless tracking and security system for a facility has particular application for an academic facility. A coordinator terminal has an integrated reader, a touchpad and a time display and a communication link for communicating with a host computer, as well an RF communication module. In one embodiment, a plurality of point-of-entry/exit terminals are connected by RF communication links and are mounted at classroom entrances within the facility. Time and attendance data entered on the terminals is compiled for transmission to the host. A panic switch may be incorporated into the terminals to provide an emergency alert and, in some embodiments, automatically lock the entrance to the classroom. Various input readers and devices can be employed at the coordinator terminal and the point-of-entry/exit terminals. The wireless tracking and security system also interfaces with terminals of a mobile carrier, such as a bus.

### BACKGROUND

This disclosure relates generally to systems and methods for recording time and attendance. More particularly, this disclosure relates generally to electronic systems that automatically monitor and record attendance.

### SUMMARY

Briefly stated, a wireless tracking system for a facility comprises a coordinator terminal and a plurality of point-of-entry/exit (“POE”) terminals. The coordinator terminal preferably has an integrated reader, a touchpad, a time display and at least one communication link for communicating with a host computer. The coordinator terminal also has an RF communication module. The POE terminals are connected to the coordinator terminal by RF communication links. Each of the POE terminals comprises an integrated ID input. Time and attendance data input at the POE terminals is compiled for transmission to the host computer.

In one embodiment, the terminals are connected by a ZigBee mesh network. Each of the POE terminals is operated on low power. At least one of the terminals preferably has a card reader. At least one of the terminals preferably also has a bioreader.

In one embodiment, each of the POE terminals has a PAN ID input via a card. The facility comprises a multiplicity of rooms with an entrance. A POE terminal is installed adjacent each of the entrances. One POE terminal embodiment has an emergency switch and an audio alarm. Activation of the emergency switch automatically generates an emergency message over the RF communication links. Activation of the emergency switch automatically dials a 911 line. In addition activation of the emergency switch triggers an electronic lock controller which locks an entrance to prevent access from the exterior of the entrance.

A mobile carrier with a mobile entrance terminal and a mobile exit terminal communicates data from the entrance and exit terminals to the coordinator terminal. In one embodiment, the mobile carrier is a school bus. The entrance and exit terminals each have an ID card reader.

A method for compiling time and attendance data for a facility having a plurality of locations comprises entering an ID at a coordinator terminal for providing access to the facility. The method also comprises entering input data comprising ID and entry/exit inputs at a plurality of POE terminals, each positioned at one of the locations. The method further comprises the step of transmitting input data between POE terminals and the coordinator terminal by RF communication and communicating input data from the coordinator terminal to a host computer.

The method has a number of embodiments. The step of entering input data comprises reading a card. The step of transmitting input data comprises a ZigBee communication. In one embodiment, the method comprises entering entrance/exit data into the terminal on a vehicle and transmitting the data via wireless communication to the coordinator terminal.

For a security embodiment, the method comprises the step of activating an emergency switch at a POE terminal and communicating data indicative of an emergency condition to the coordinator terminal. In addition, an audio alarm may be activated at the POE terminal, and an entrance at the location may be automatically locked.

A wireless tracking system for a facility having a multiplicity of controlled spaces with an entrance comprises a coordinator terminal having an input device, a communication link and an RF communication module. A plurality of low power POE terminals are located adjacent at least some of the entrances and are connected with the coordinator terminal by RF communication. Each POE terminal has a reader. Input from the reader is employed to compile time and attendance data at the POE terminal, which data is transmitted by RF communication to the coordinator terminal. At least one POE terminal has an emergency switch which is accessible by displacing a cover.

The coordinator terminal preferably has a camera and at least one reader selected from the group consisting of a card reader, an RFID reader, a bioreader, a magnetic strip reader, a barcode reader and a proximity reader. The coordinator terminal communicates with a host computer via WI-FI, cellular, Bluetooth or Ethernet communication.

### BRIEF DESCRIPTION OF THE DRAWINGS

FIG. 1 is an annotated block diagram of a wireless time and attendance (“T & A”) system which has application as a student tracking system for an academic facility;

FIG. 2 is an annotated block diagram of a coordinator terminal for the T & A system of FIG. 1;

FIG. 3 is an annotated block diagram for a point-of-entry (“POE”) terminal for the T & A system of FIG. 1;

FIG. 4 is an annotated block diagram of a range extender router for the T & A system of FIG. 1;

FIG. 5 is an annotated block diagram of a wireless T & A system for a gateway;

FIG. 6 is an annotated block diagram of a gateway coordinator computer for the system of FIG. 5;

FIG. 7 is an annotated side elevational view, partly in phantom, of a modified terminal which may be employed as a POE and a security terminal;

FIG. 8 is an annotated diagrammatic view, partly in phantom, of a rear portion of the terminal of FIG. 7;

FIG. 9 is a fragmentary view, portions removed, of a component board for the terminal of FIG. 7 and a PAN ID card further illustrating how the card may be inserted into the terminal board;

FIG. 10 is an annotated schematic view illustrating how a mobile carrier tracking system may be incorporated into the student tracking system for the academic facility of FIG. 1 or FIG. 5;

FIG. 11 is an annotated system block diagram for a wireless T & A network with a gateway (coordinator) module and door access control for a wireless student tracking system integrated with a mobile unit;

FIG. 12 is an annotated system block diagram of a wireless T & A network and a coordinator time terminal with bioreaders and printers for a wireless student tracking and security system for an academic facility (hereinafter “student tracking system”);

FIGS. 13 and 14 are each an annotated block diagram for a coordinator terminal with USB, bioreader, panic and printer options for a wireless student tracking system;

FIG. 15 is an annotated block diagram of a coordinator terminal incorporating a camera and WI-FI, Bluetooth and ZigBee communication capability and UPS with a proximity reader, an RFID reader, a barcode reader and a magnetic strip reader connected via a USB port and a power module, for a student tracking system;

FIG. 16 is an annotated block diagram for a coordinator terminal with a bio reader with an audio alert, power switch, and a printer connected via a USB port and a power module, employed in the student tracking system;

FIG. 17 is an annotated block diagram of a wireless T & A network with a coordinator terminal having the combined capability of the terminals of FIGS. 15 and 16 including a bioreader, various readers, a panic switch, serial input/output and a ZigBee capability, and connected with an input/output module for a student tracking system;

FIG. 18 is an annotated block diagram for a wireless T & A network including a coordinator terminal having the capability of FIG. 17 including a bioreader, a panic switch, serial input/output and a ZigBee capability, and connected with the Ethernet and a power module, for a student tracking system;

FIGS. 19 and 20 are annotated block diagrams of a USB hub with an Ethernet converter for a student tracking system;

FIGS. 21 and 22 are annotated block diagrams for a USB to ZigBee protocol with a panic input/output capability for a student tracking system;

FIG. 23 is an annotated block diagram for a bioprint input/output card for a touch time terminal with a bioprint reader and a panic button;

FIG. 24 is an annotated block diagram for the USB to input/output for a panic button/audio alert and bioprint reader for a touch time terminal for a student tracking system;

FIGS. 25 and 26 are annotated block diagrams for a switch input/output to a USB, an auxiliary input/output and a panic alarm input/output function for a student tracking system;

FIGS. 27-30 are annotated block diagrams for a terminal speaker amplifier and power input/output card for a terminal for a student tracking system;

FIGS. 31-35 are annotated block diagrams for a terminal microphone card with audio amplifier and speaker for a student tracking system;

FIGS. 36 and 37 are annotated block connector diagrams for a POE terminal of a student tracking system;

FIGS. 38A and 38B are respectively an enlarged front view and a side view, partly in phantom, of a periscope employed with a camera for a high resolution camera for a terminal of a student tracking system; and

FIG. 39 is an enlarged front view of a NFR card guide for a terminal for a student tracking system.

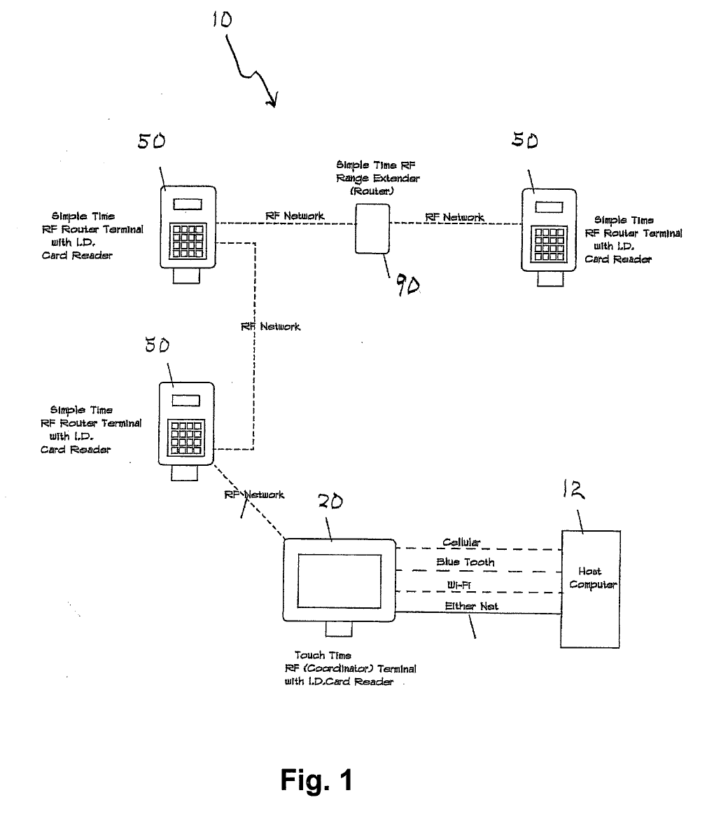

### DETAILED DESCRIPTION

With reference to the drawings, wherein like numerals represent like parts throughout the figures, a wireless time and attendance (“T & A”) system is generally designated by the numeral 10. The wireless time and attendance system 10 is particularly adapted to automatically collect data to compile the attendance of various individuals at separate spaces within a facility for various time intervals throughout a session or extended time period. The wireless T & A system 10 has particular applicability in connection with tracking the attendance of students within multiple classrooms or areas of an academic facility, such as a school or building, throughout the day or over an extended date range and for automatically compiling data for attendance records and transmitting data to a central host computer 12. The subject wireless tracking and security system is not limited to students but is applicable to any individuals and is not limited to academic facilities.

The wireless T & A system 10 employs a management or coordinator gateway terminal 20 which communicates via radio frequency (“RF”) directly or indirectly with a plurality of point-of-entry/exit (“POE”) router terminals 50. The coordinator terminal 20 is a low power device preferably located at the entrance/exit of the facility. The POE terminals 50 are located at each entrance/exit of a location, such as a classroom, within the facility. The POE terminals 50 also operate on low power. Each of the terminals is mounted for easy access and input by numerous users. The communication between the various terminals is preferably accomplished by a ZigBee mesh network so that the system can be installed, replaced, modified and/or expanded if necessary, without extensive hard wiring between the various terminals. The wireless T & A system 10 is highly flexible and easily adapted to a wide range of applications.

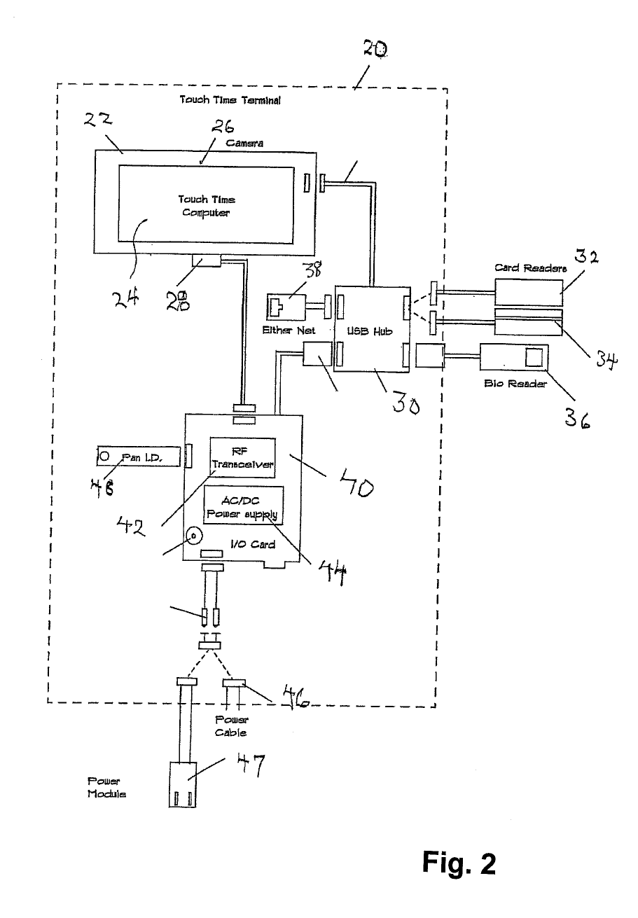

With additional reference to FIG. 2, the coordinator terminal 20 includes a computer 22 with a touch screen 24. The terminal 20 also has a camera 26. A USB hub 30 functions as a communication center for the computer 22. The individual user enters an ID which can be entered by means of a card reader, a fingerprint or biometric identification, proximity sensor or a full identification. The screen 24 also prominently displays the time and the date and provides an in and out touchpad as well as numerous other touchpad choices. For some embodiments, the terminal may also include a microphone and a speaker to allow for voice communication with a remote terminal. The hub 30 connects with a barcode reader 32, a magnetic card reader 34 and/or a bio-reader 36. Preferably, the reader ports include barcode, magnetic, proximity, smart code and biometric capabilities. The USB hub 30 also bi-directionally communicates with the Ethernet 38.

An input/output card 40 includes an RF transceiver 42 powered by an AC/DC power supply 44. The input/output card 40 connects with an I/O port 28 of the computer 22 and with the hub 30. Power is supplied to the power supply 44 via a power cable 46 or a power module 47. The PAN ID, which may be placed on a card or a memory stick, is input into the input/output card via socket 48.

The coordinator terminal 20 also preferably includes the capability of validating an input and allowing access through a controlled door, gate or other barrier to the facility. The terminal is capable of communicating via numerous links, such as WI-FI, Bluetooth and cellular. In one preferred application, the coordinator terminal 20 communicates via WI-FI with the host computer 12 and also communicates via the Ethernet with the host. Other communication protocols are also possible.

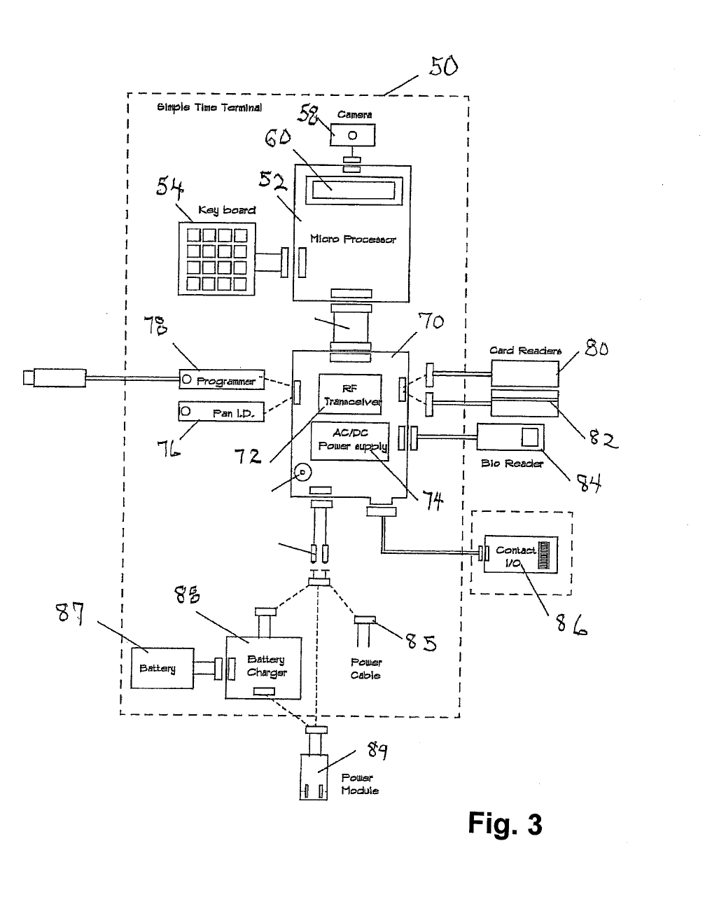

With additional reference to FIG. 3, each POE terminal 50 has a microprocessor 52 which receives input from a keypad 54 and communicates with a screen 60. The screen 60 functions to display the time and date and as a touch screen with touch pads for inputting “in” and “out” designations. The microprocessor also receives input from a camera 58.

The POE terminal 50 employs ZigBee communication components and codes to connect the POE terminal 50 to the coordinator terminal 20 and/or to connect the terminal with other terminals 50. For some systems, the terminals communicate via WI-FI.

An input/output card 70 includes an RF transceiver 72 powered by an AC/DC power supply 74. The card 70 receives input from a proximity card reader 80, a magnetic strip reader 82, or a bio-reader 84, and communicates with a contact input/output reader 86. The students, for example, can use their cards, a PIN or a fingerprint to provide identification and then use the keypad or screen to indicate whether they are entering or leaving a location. In some embodiments, the POE terminal 50 provides a controlled access through the door of a classroom or other defined space of a facility.

The low power for the terminal 50 may be supplied from either a power cable 85, or a battery power supply 87 or a power module 89. The terminal preferably includes a battery charger 88. The network address and programming for each terminal is input through a PAN ID which is placed on a card, a memory stick or a USB flash drive 76 or a programmer connector 78 which plugs to the input/output card 70.

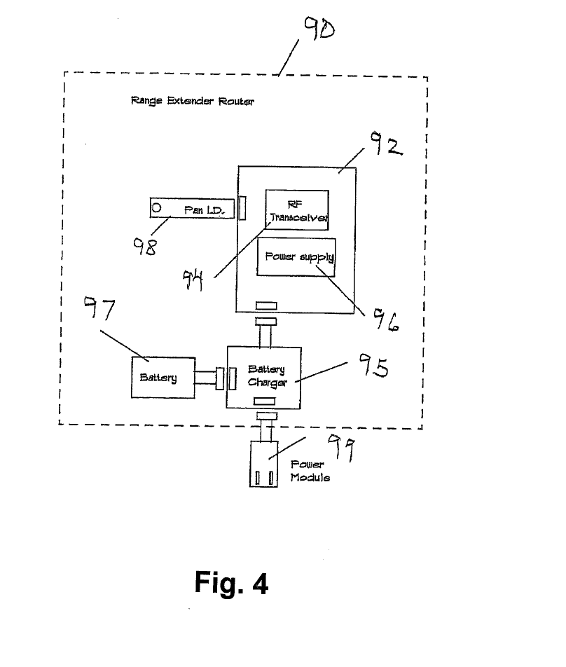

In order to provide additional range for the wireless T & A system, a range extender router 90, such as illustrated in FIG. 4, is employed. The input/output card 92 has an RF transceiver 94 and a power supply 96. The power supply 96 connects via a battery charger 95 for a battery power supply 97 or a power module 99. A PAN ID on a memory stick, a card 98 or a programmer connector provides address/routing codes to the input/output card 92. The RF transceiver 94 communicates with various POE terminals as required.

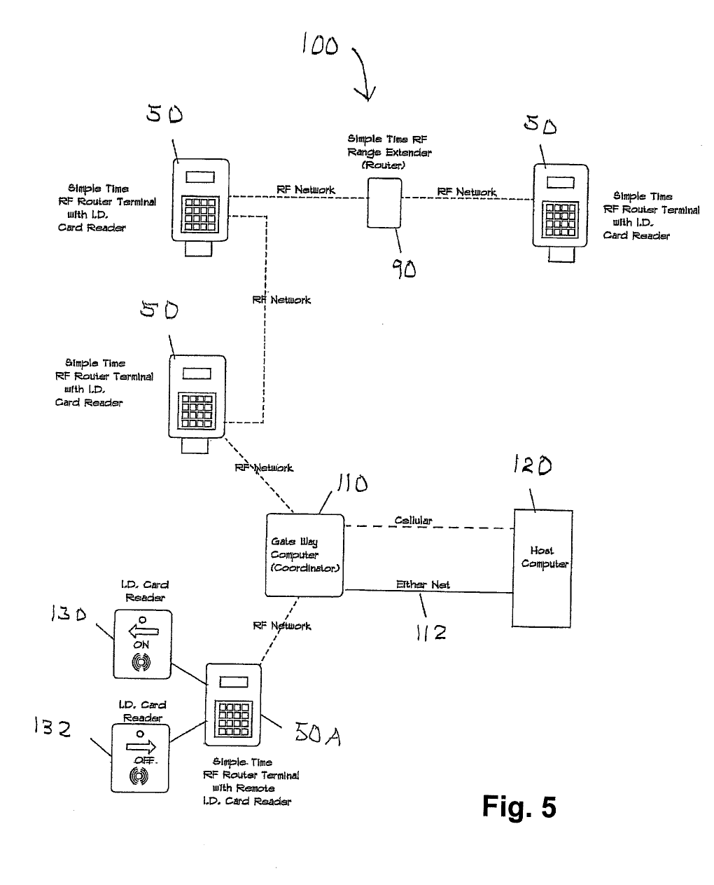

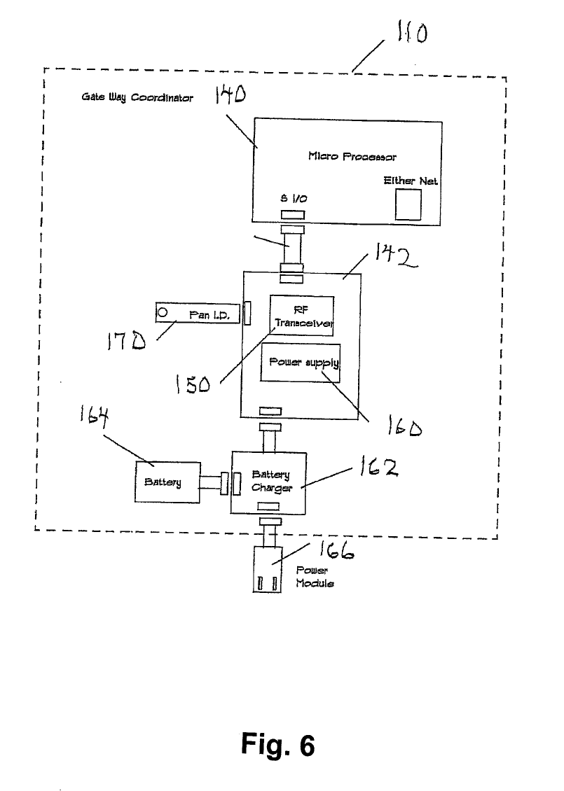

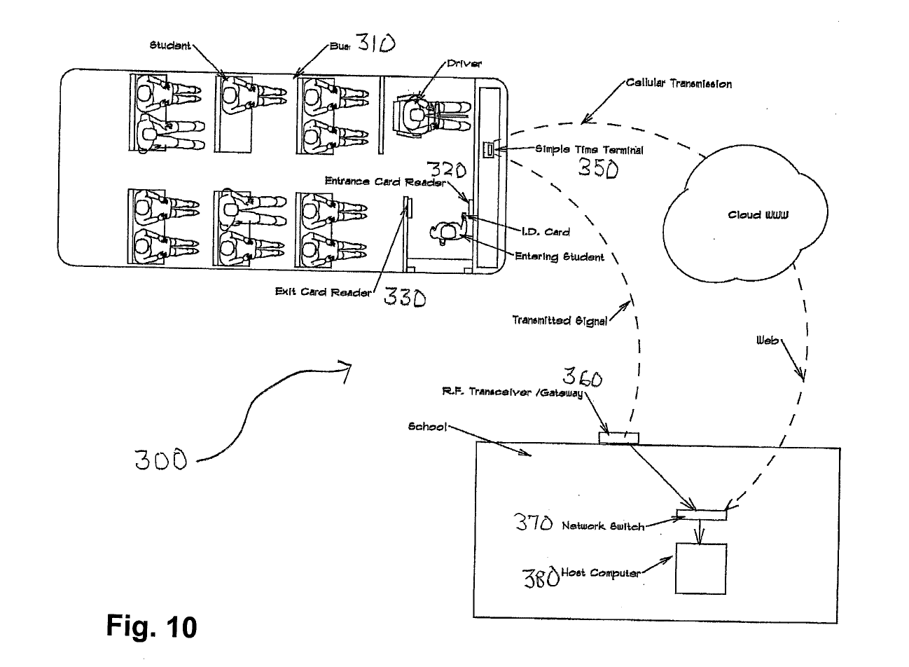

With reference to FIGS. 5 and 6, the T & A network system may also be employed in the context of a gateway network system 100 which securely controls access to numerous locations, such as classrooms, lecture halls, auditoriums, etc., within a facility. A gateway coordinator computer 110 communicates via cellular link or an Ethernet link 112 with a host computer 120. The gateway computer 110 also communicates via an RF network with multiple RF terminals 50. The gateway computer 110 also communicates over an RF network with a router terminal 50A having an ID card reader 130 for entering the facility or an ID card reader 132 for exiting the facility. The facility interface is related to the expanded system illustrated in FIG. 10 and described below. The computer also communicates with multiple simple RF router terminals 50 with an ID card reader via an RF network as previously described. An RF range extender router 90 or multiple routers can also be employed to extend the range of the RF network.

With reference to FIG. 6, the gateway coordinator computer 110 comprises a microprocessor 140 which has an Ethernet port 142. The microprocessor 140 communicates with an input/output card 144 having an RF transceiver 150 and a power supply 160 which operates on low power. The power supply 160 connects via a battery charger 162 with a battery 164 or a power module 166. The PAN ID 170 for the RF transceiver is placed on a card (or a flash drive or memory stick) and connected to the input/output card 142 to provide the routing for the various RF communications.

It will be appreciated that the network of POE router terminals 50 can be installed at locations spaced at relatively long distances within a facility. The ZigBee mesh network will allow for relatively large distances without wiring between the various terminals. Each ZigBee module within the POE unit has a unique address. Each terminal has a unique PAN ID that identifies all of the nodes for which each of the ZigBee modules communicates. A programming stick or card containing the PAN ID or other input device is inserted into a socket of each terminal for ready incorporation of the appropriate PAN ID into each of the terminals 20, 50 and 110. For facilities that have WI-FI, the terminals can communicate via WI-FI communication rather than ZigBee communication.

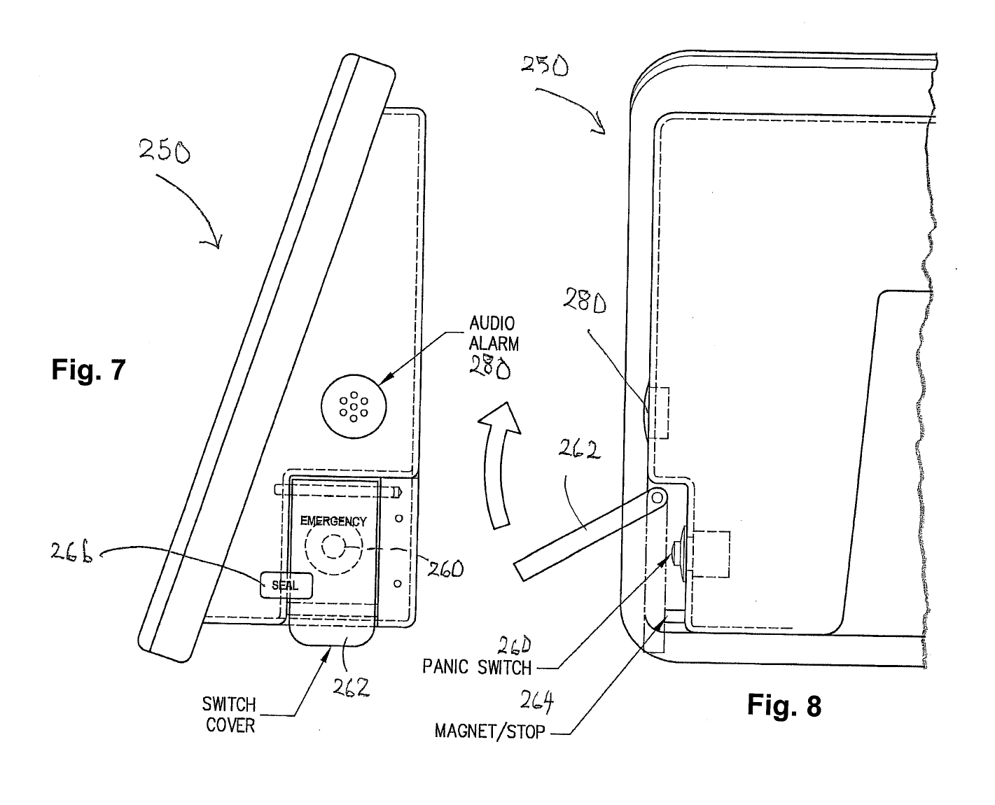

The tracking system is also adaptable to efficiently incorporate a security system. With reference to FIGS. 7-9, a modified POE terminal 250 includes a security module at one side. A panic button or switch 260 is mounted at a lower side location. A pivotal cover 262 for the switch is labeled with an “EMERGENCY” designation. In a closed position, the cover 262 engages a stop 264 which also includes or is adjacent a magnet for maintaining the switch cover in a closed position. In one preferred application, a seal 266 is affixed to bridge over the switch cover exterior and the adjacent rear panel of the terminal. When the cover is raised (in the direction of the FIG. 8 arrow), the seal 266 will be broken to indicate that the panic switch 260 has been accessed. In addition, an audio alarm speaker 280 is disposed at the side of the terminal housing for audibly indicating an alarm or emergency situation upon activating the switch 260. Each of the POE terminals 250 may be equipped with the panic switch and audio alarm features.

It should also be appreciated that activation of the panic switch 260 will alert authorities of an emergency situation over the wireless network and will automatically dial 911. The panic switch 260 can also be configured to trigger electronic door locks (not illustrated in FIGS. 7-9), immediately locking the doors to prevent access from the outside.

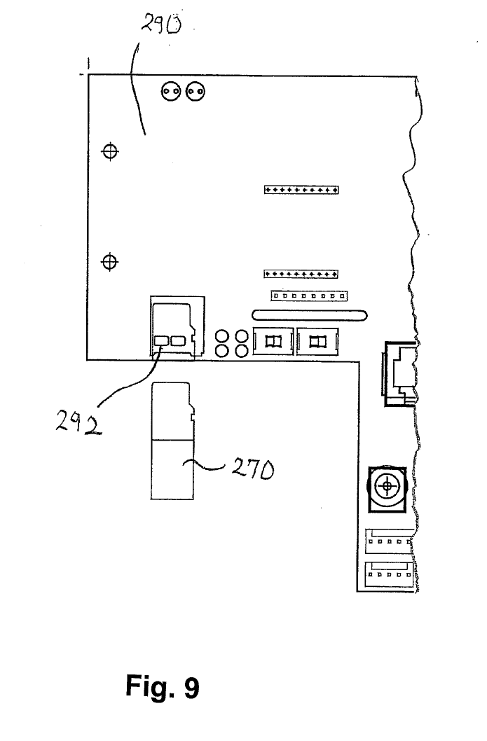

The component board 290 for the terminal illustrated in FIG. 9 also indicates how the PAN ID card 270 may be inserted into a socket 292 of the terminal board for providing the network address for the terminal and the wireless communication path to and from the terminal. The socket 292 may be accessible at the underside base for the terminal. The terminal is equipped with a battery backup and a 64 gigabyte internal memory data backup. If the network is not available, the data is not lost and information is stored and validated at the terminal until the network for the terminal regains its online status.

The use of multiple individually programmed PAN ID cards 270 can allow for up to 98 units, e.g., POE terminals 250, to connect to a single gateway terminal. Each of the POE terminals requires only a single IP address. This dramatically reduces the system complexity and the organizational protocol required to provide a facility-wide system. In this regard, it should again be appreciated that the terminals can simply be plugged into a pre-installed multipurpose power line without requiring an electrician. No network wiring and no power management setup is required. The gateway terminal and the POE terminals 250 may easily be wall mounted.

The terminals employ WI-FI communication in some system installations. Ethernet and cellular communications are optional. Consequently, no wiring is required between the POE terminals and the gateway terminal. Each of the terminals is preferably capable of being equipped with ZigBee wireless communication. Such communication provides a highly secure machine-to-machine data transfer that does not burden any existing networks.

With reference to FIG. 10, a student tracking system 300 extended to a mobile carrier, such as bus 310, may be further integrated with the facility tracking systems 10 and 150, as previously described. The bus 310 includes an entrance ID card reader 320 and an exit ID card reader 330. The card readers 320 and 330 communicate with a POE terminal 350. The terminal 350 can communicate via RF wireless with a gateway transceiver 360 at the school facility. Students can thus be tracked when they enter and exit the bus. In addition, the terminal 350 preferably has a cellular capability to provide cellular transmission over the web. Both types of communications can be received via a network switch 370 and communicate through the host computer 380 for the facility. In an alternate embodiment, readers 320 and 330 are integrated into a single reader module.

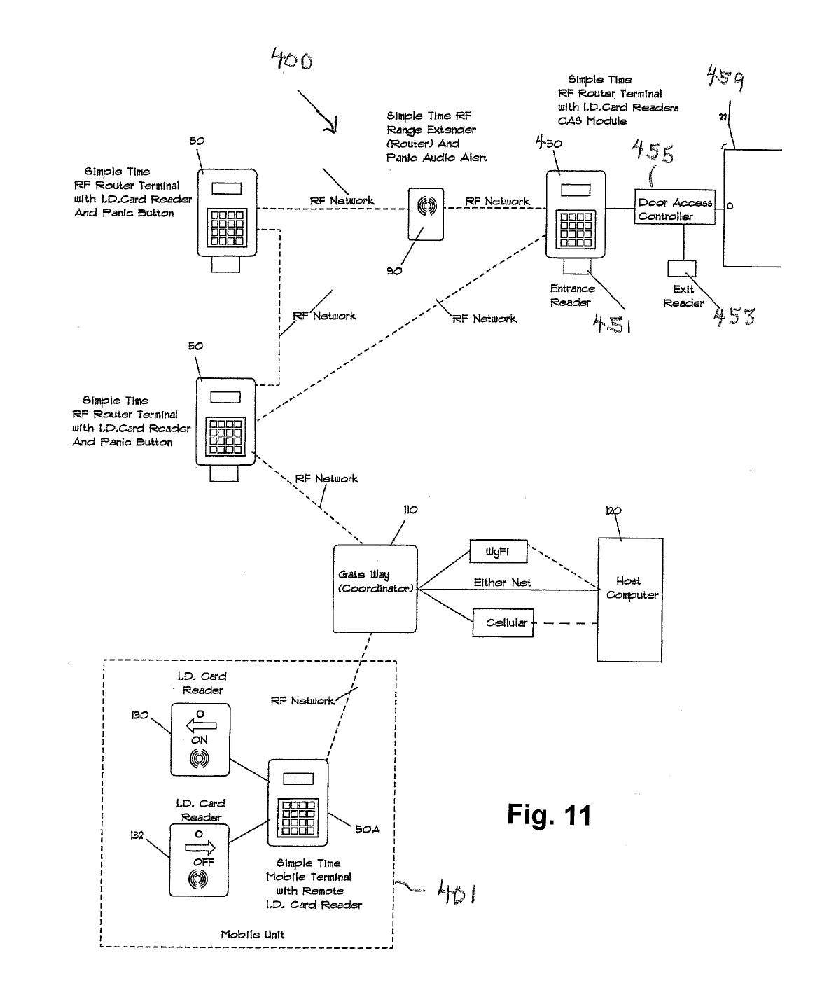

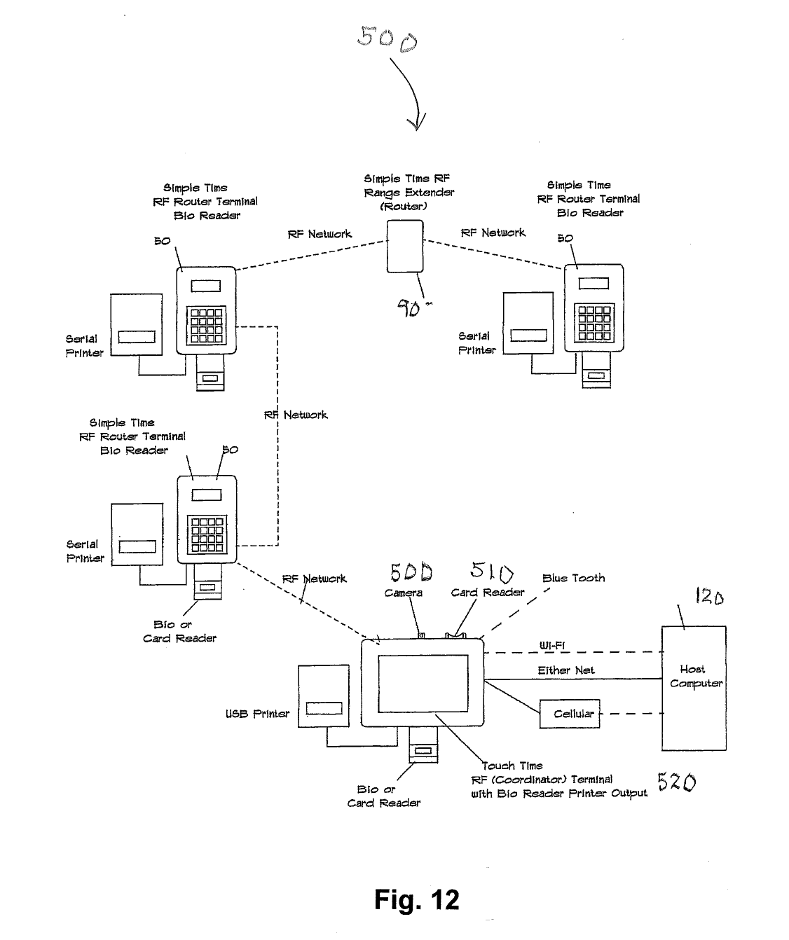

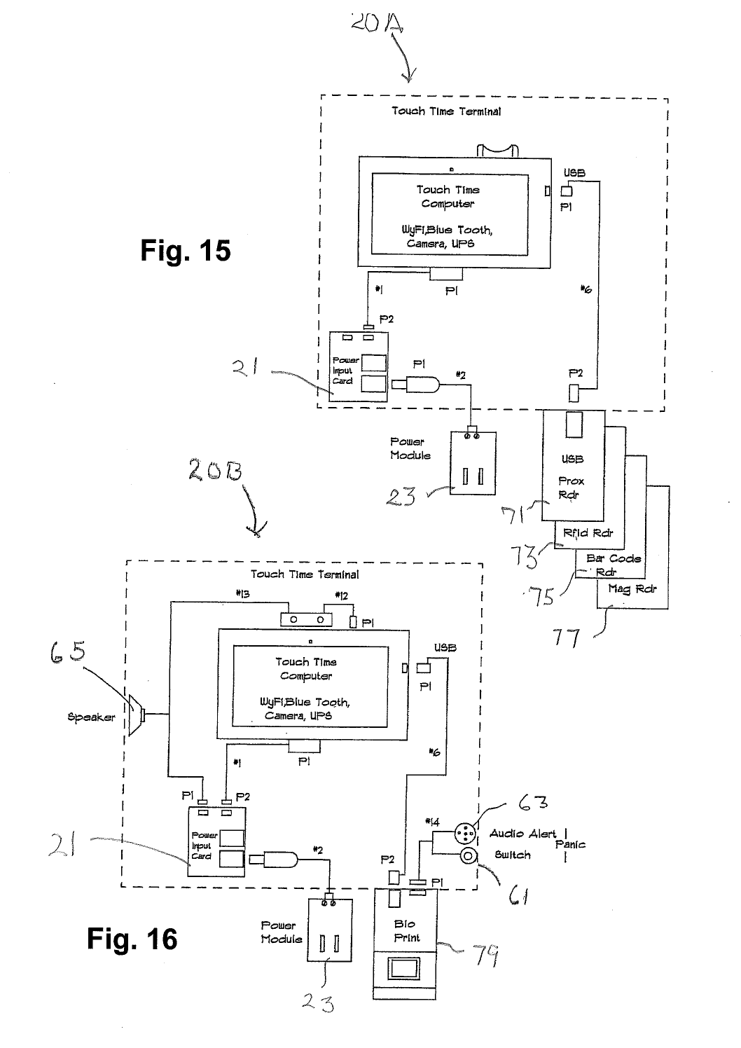

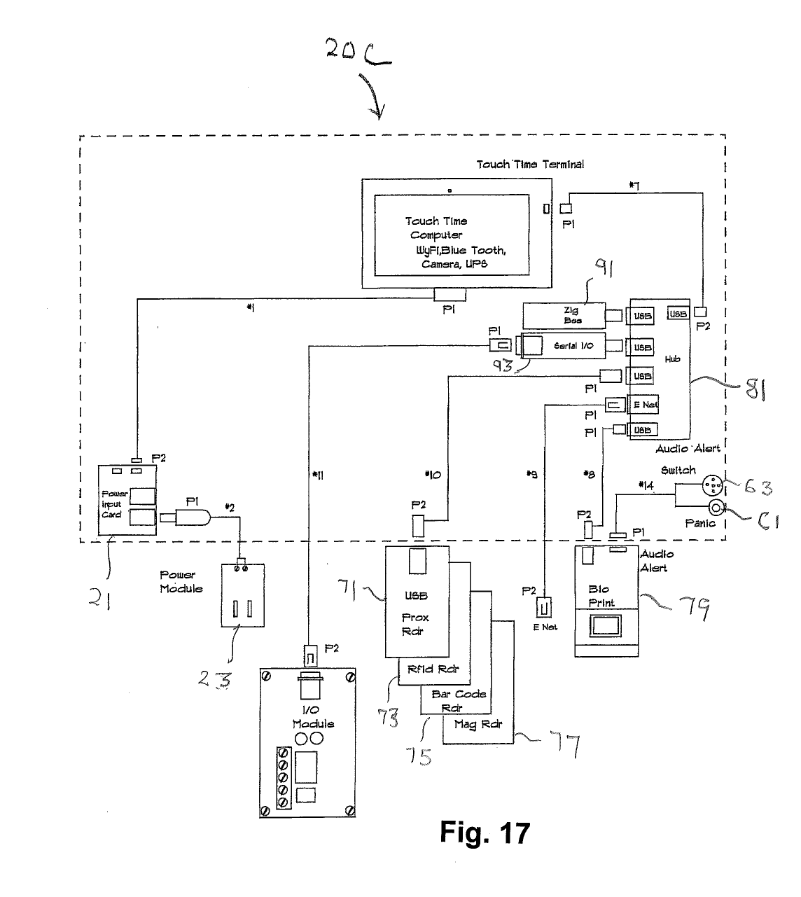

With reference to FIGS. 11-39, it should also be appreciated that both the gateway terminals and the POE terminals have a myriad of additional optional capabilities and provide a wide range of flexibility. FIGS. 11 and 12 schematically illustrate many of the capabilities with the context of a wireless network for a student tracking system. For example, barcode, card swipe, keypad, magnetic swipe and proximity sensor identification modules (FIGS. 15, 17) may also be readily installed and connected for operation. In addition, biometric fingerprint identification can also be integrated with the terminals (FIGS. 16, 18, 24). Typically, each POE terminal is equipped with two different identification modes and is modularly designed for selectively implementing additional features.

With reference to FIG. 11, a wireless tracking and security network 400 is configured to provide door access control and to be integrated with a representative mobile unit 401. A POE terminal 450 employs an entrance reader 451 and an exit reader 453. A door access controller 455 controls access to a door 459. In an emergency situation, the door access controller 455 can automatically implement a locking protocol so that entrance to the door 459 is automatically locked. The wireless tracking system 400 also includes an RF connection with the mobile unit 401 over an RF network with the gateway or coordinator 110. In this fashion, for example, students may be tracked once they board a school bus and can be subsequently tracked upon exiting the school bus. Multiple mobile units are possible and typically employed.

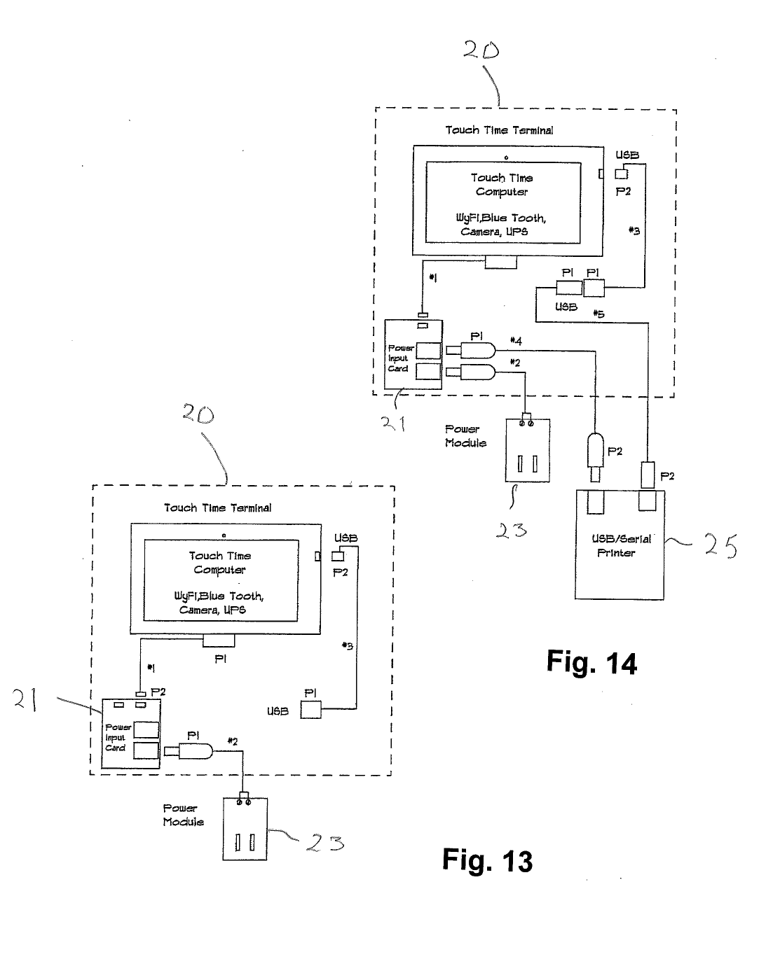

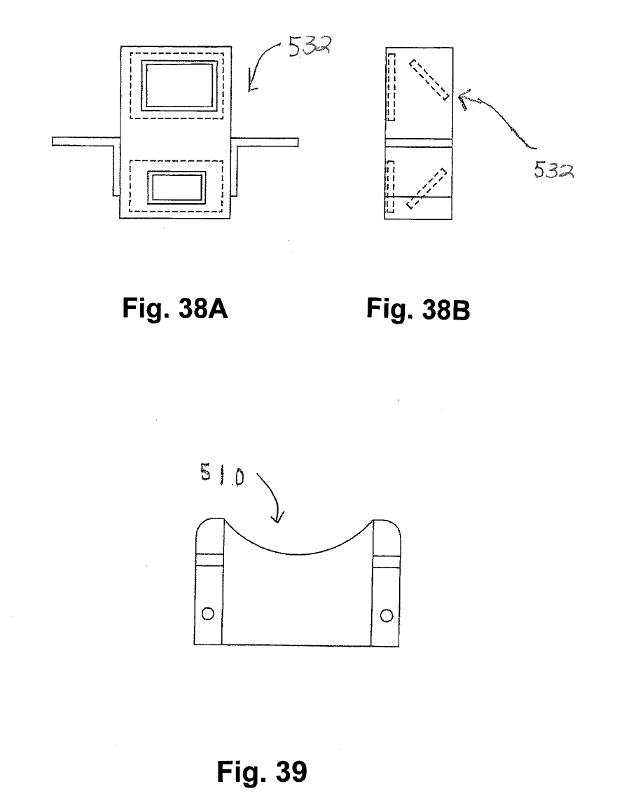

A representative coordinator terminal 520 is shown for the time and attendance system 500 in FIG. 12. The terminal has a high resolution camera 530. A periscope 532 for a schematic high-resolution camera 530 is built into the terminal housing for the tracking system is illustrated in FIGS. 38A 38B. A card guide 540 may also be built into the coordinator terminal 520 of FIG. 12 as further illustrated in FIG. 39. The coordinator terminal 520 has a power input card 21 which connects with a power module 23 (FIG. 13). The terminal is also capable of connecting via a USB port with a serial printer 25 (FIG. 14).

The terminals 20 and 20A-20D FIGS. 13-18 have a computer and camera and preferably incorporate uninterrupted power supply (UPS) and WI-FI and Bluetooth communication capability.

With reference to FIGS. 13 and 14, terminal 20 has a power output card 21 to provide a connection with a power mobile 23. A USB port allows for a connection with a serial printer 25.

With reference to FIG. 15, terminal 20A has a USB port to provide the capability of connecting with a proximity reader 71, an RFID reader 73, a barcode reader 75 and a magnetic strip reader 77. A bioprint reader 79 is also employed as an input for the terminal 20B in FIG. 16 and terminal 20C in FIG. 17.

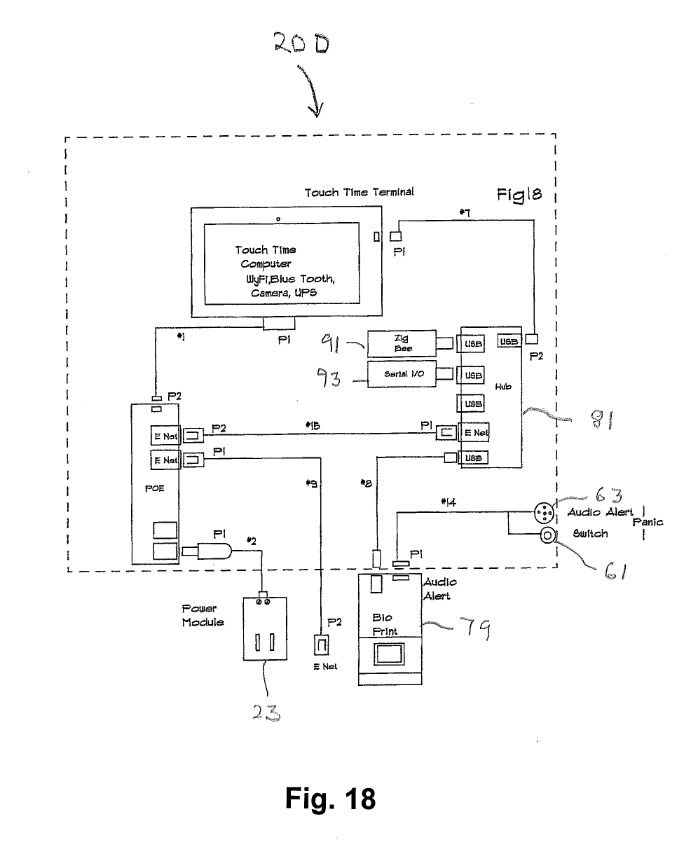

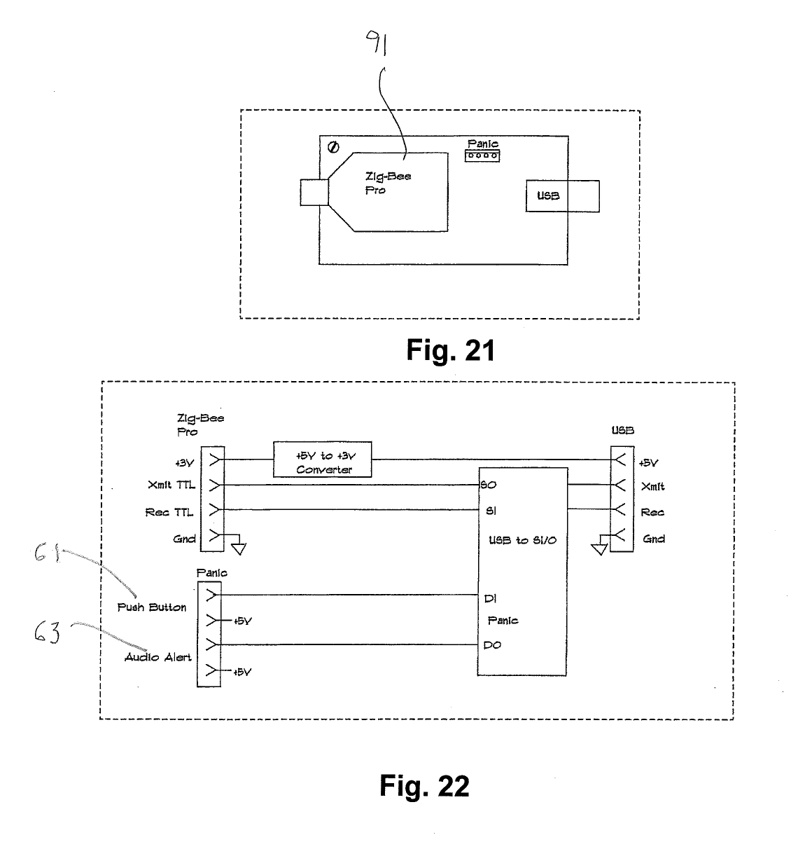

Terminal 20B is additionally configured with a panic switch 61 and an audio alert 63 as well as a speaker 65. The panic switch feature and audio alert is also employed in the terminals 20C and 20D of FIGS. 17 and 18. FIGS. 21-28 illustrate how the panic switch feature can be implemented at a terminal.

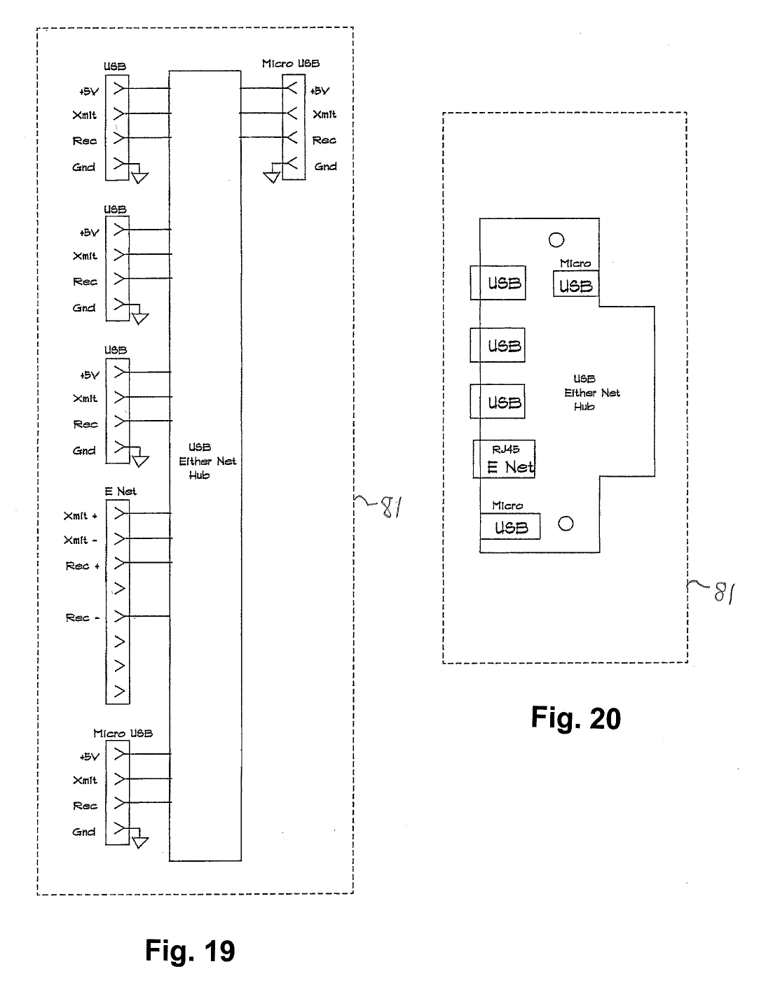

Terminal 20C and terminal 20D each incorporates a USB Ethernet hub 81. The hub 81 provides for communication with the ZigBee module 91, a serial input/output module as well as the panic switch 61 and the audio alert 63 (see FIGS. 19 and 20). FIGS. 21 and 22 further illustrate the ZigBee processor 91 as well as the panic switch 61 connections for the terminals.

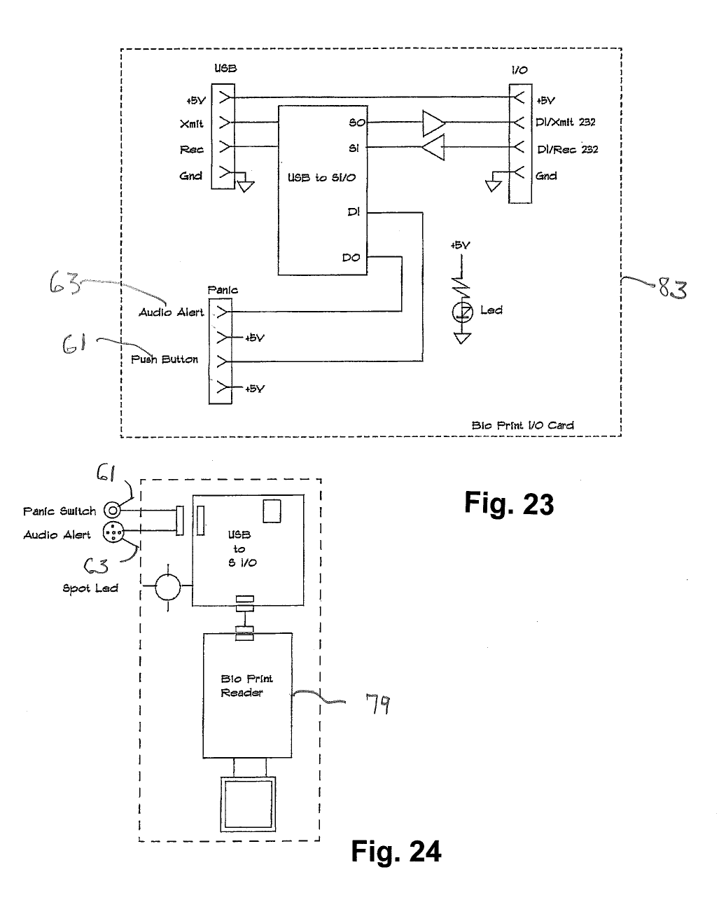

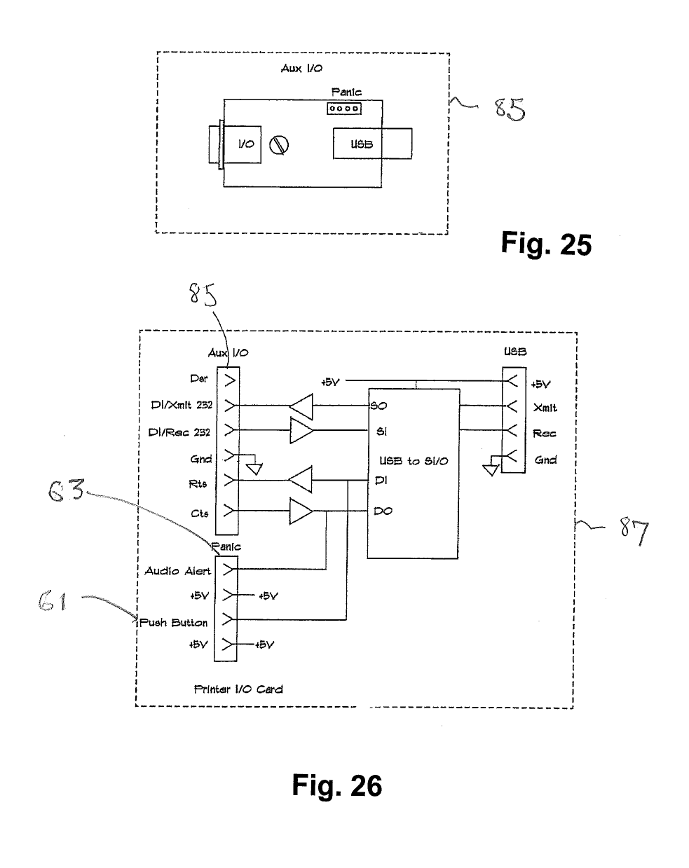

FIGS. 23 and 24 illustrate how the bioprint reader 79 is connected with the panic switch and audio alert functions of the terminal via a bioprint I/O card 83. FIGS. 25 and 26 further illustrate an auxiliary I/O, 85 for implementing the panic switch feature and the printer connection via printer input/output card 87 for the terminal.

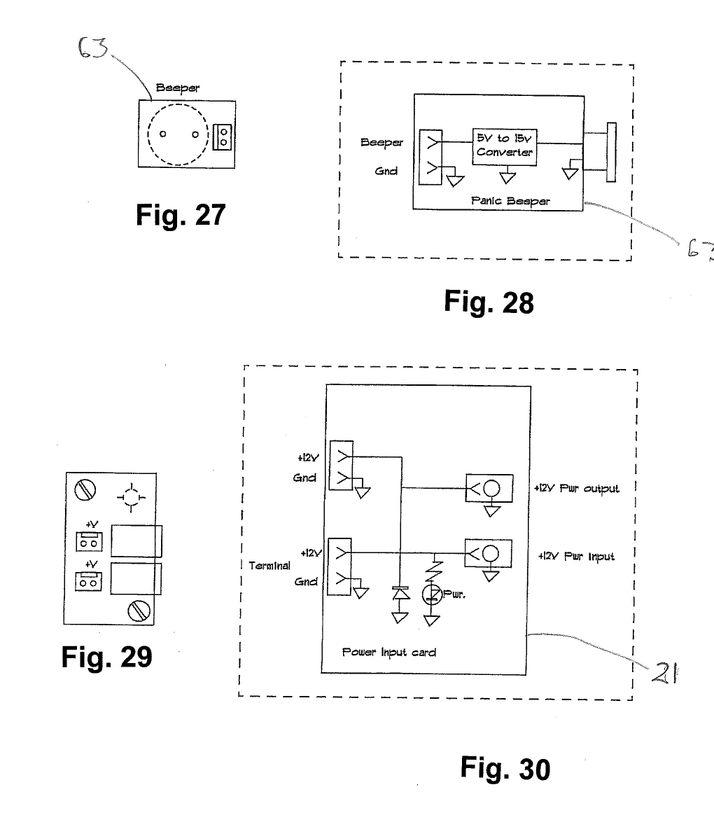

FIGS. 27 and 28 illustrate the beeper function of the audio alert 63 for the terminals. FIGS. 29 and 30 further illustrate the power input card connection 21 for the terminals.

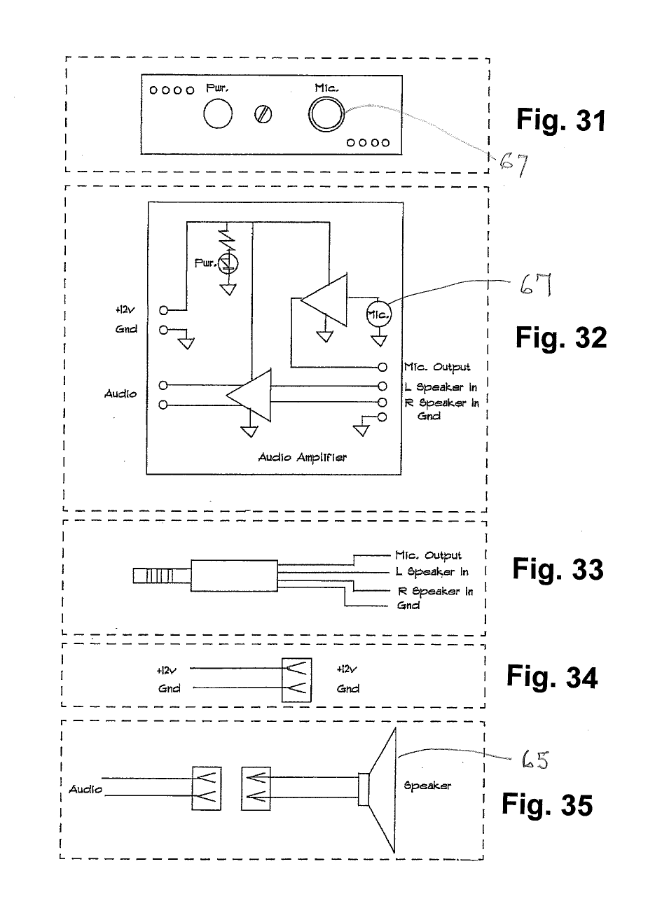

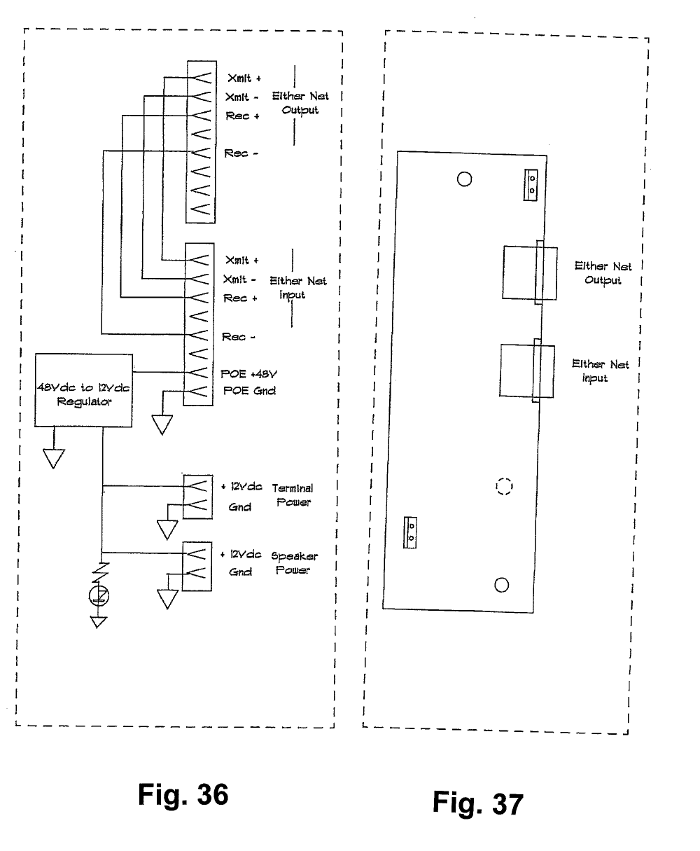

The speaker 65 and microphone 67 features and functions are further illustrated in FIGS. 31-35 for the terminals. FIGS. 36 and 37 further show the power and communication connections for the terminals.

The terminals preferably include a built-in two megapixel camera (FIGS. 11, 13-16) capable of capturing and recording images. The terminals only require a regular 15 amp outlet for installation and operation. If a POE terminal or a gateway terminal is located beyond the standard 30-foot wireless signal range, range extenders can also be implemented.

In some embodiments of the wireless tracking and security system, the POE terminals may have substantially the same features as those described for the coordinator or gateway terminals.

While preferred embodiments of the wireless tracking and security system have been described herein, the foregoing description should not be deemed a limitation of the invention. Accordingly, various modifications, adaptations and alternatives may occur to one skilled in the art without departing from the spirit and the scope of the present invention.

1. A wireless tracking system for a facility comprising:
a coordinator terminal having an integrated reader, an input device, a microprocessor, a display, at least one communication link for communicating with a host computer and an RF communication module;
a plurality of point-of-entry/exit (“POE”) terminals connected to said coordinator terminal by RF communication links, each said POE terminal comprising an integrated ID input;
wherein time and attendance data input at said POE terminals is compiled for transmission to said host.

2. The wireless system of claim 1 wherein said terminals are connected by a ZigBee mesh network.

3. The wireless system of claim 1 wherein each of said POE terminals is operated on low power.

4. The wireless system of claim 1 wherein at least one of said terminals comprises a card reader.

5. The wireless system of claim 1 wherein at least one of said terminals comprises a bio-reader.

6. The wireless system of claim 1 wherein each of said POE terminals has a PAN ID input via a card.

7. The wireless system of claim 1 wherein at least one POE terminal has an emergency switch.

8. The wireless system of claim 7 wherein said at least one POE terminal has an audio alarm.

9. The wireless system of claim 1 wherein said facility comprises a multiplicity of rooms with an entrance and a POE terminal is installed adjacent each said entrance.

10. The wireless system of claim 7 wherein activation of the emergency switch will automatically generate an emergency message over the RF communication links.

11. The wireless system of claim 7 wherein activation of the emergency switch automatically dials a 911 line.

12. The wireless system of claim 7 wherein activation of the emergency switch triggers an electronic lock controller which locks an entrance of a facility location to access from exterior of the entrance.

13. The wireless system of claim 1 further comprising a mobile carrier with a mobile entrance terminal and a mobile exit terminal and further comprising communicating data from said entrance and exit terminals to said coordinator terminal.

14. The wireless system of claim 13 wherein said mobile carrier is a school bus.

15. The wireless system of claim 13 wherein said entrance and exit terminals each have an ID card reader.

16. A method for compiling time and attendance data for a facility having a plurality of locations comprising:
entering an ID at a coordinator terminal for providing access to said facility;
entering an input data comprising ID and entry and exit inputs at a plurality of POE terminals each positioned at one of said locations;
transmitting input data between said POE terminals and said coordinator terminal via RF communication; and
communicating said input data from said coordinator terminal to a host computer.

17. The method of claim 16 wherein the step of entering input data comprises reading a card.

18. The method of claim 16 wherein the step of transmitting input data comprises a ZigBee communication.

19. The method of claim 16 further comprising entering entrance and exit data into a terminal on a vehicle and transmitting said data via wireless communication to said coordinator terminal.

20. The method of claim 16 further comprising activating an emergency switch at a POE terminal and communicating data indicative of an emergency condition to said coordinator terminal.

21. The method of claim 20 further comprising activating an audio alarm at said POE terminal.

22. The method of claim 20 further comprising automatically locking an entrance to a location.

23. A wireless tracking system for a facility having a multiplicity of controlled spaces with an entrance comprising:
a coordinator terminal having an input device, a microprocessor, a communication link and an RF communication module;
a plurality of low power POE terminals adjacent at least some of said entrances and connected with said coordinator terminal by RF communication, each said POE terminal having a reader;
wherein input from said reader is employed to compile time and attendance data at said POE terminal which data is transmitted by RF communication to said coordinator terminal.

24. The wireless system of claim 23 wherein at least one POE terminal has an emergency switch which is accessible by displaying a cover.

25. The wireless system of claim 23 wherein said coordinator terminal has a camera and at least one reader selected from the group consisting a cloud reader, an RFID reader, a bioreader, a magnetic strip reader, a barcode reader and a proximity reader.

26. The wireless system of claim 23 wherein the coordinator terminal communicates with a host computer via WI-FI, cellular, Bluetooth or Ethernet communication.

27. The wireless system of claim 23 wherein said input device is selected from the group consisting of a touchpad, a screen display and a keyboard.
